(19) United States
(12) Patent Application Publication
(10) Pub. No.: US 2018/0338492 A1
(43) Pub. Date: Nov. 29, 2018

(54) IMPROVED BIOCIDE COMPOSITIONS BASED ON MAGNESIUM FLUORIDE AS WELL AS USES THEREOF

(71) Applicant: Flechsig Patent Company LLC, Cham (CH)

(72) Inventors: Frank FLECHSIG, Wohlen (CH); Thomas FLECHSIG, Hermetschwil-Staffeln (CH)

(21) Appl. No.: 15/771,761

(22) PCT Filed: Oct. 26, 2016
(86) PCT No.: PCT/EP2016/001784

§ 371 Date: Apr. 27, 2018

(30) Foreign Application Priority Data
Oct. 28, 2015 (CH) 01574/15

(51) Int. Cl. A01N 37/40; A01N 37/10; A01N 37/36; A01N 59/06; A01N 47/44

(52) U.S. Cl. CPC A01N 37/40; A01N 37/10; A01N 47/44; A01N 59/06; A01N 37/36

(57) ABSTRACT

The present invention relates to improved biocide compositions based on magnesium fluoride which are suitable for a broad range of applications including surface disinfectants, additives to construction materials and paints, antiseptic medical and cosmetic formulations, as a crop protection product and as a fast-acting disinfectant. The biocide composition of the invention comprise at least the following components: a) magnesium fluoride b) a salicylic acid ester c) at least one organic acid selected from the group comprising or consisting of cinnamic acid, rosmarinic acid, vanillic acid, ascorbic acid, abscisic acid, mandelic acid, mevalonic acid, aspartic acid, salicylic acid, fumaric acid, isocitric acid, gallic acid, quinic acid, boswellic acid, carnosic acid, chlorogene acid, caffeic acid, other hydroxycarboxylic acids, or a salt or ester thereof, or thymol or citronellal. d) a cationic polymer and/or natural sea salt or a synthetic equivalent thereof and/or a cationic tenside, e) water. In preferred embodiments, the cationic polymer is selected from the group comprising or consisting of a poly(alkylene)guanidin or -biguanidin, or octenidin, and the organic acid is cinnamic acid and/or quinic acid.

### BACKGROUND

The present invention relates to improved biocide compositions in an aqueous solution based on magnesium fluoride which are suitable for a broad range of applications including the provision of antimicrobial activity on living tissue/skin, such as medical antiseptics, the provision of antimicrobial activity on other surfaces, such as general disinfectants in medical and non-medical fields, and/or the provision of antimicrobial activity or prevention of microbial activity, in particular fungal activity, in non-living objects, such as in additives to construction materials and paints or in a crop protection product.

Generally, it is desired to have fast acting and persistent antiseptics and disinfectants. It is further desired that crop protection products have a persistent antimicrobial activity.

Antiseptics or disinfectants are usually considered as “fast acting” if they achieve a significant reduction of the number of target micro-organisms in a time period of less than minutes following application of the antiseptic.

The term “persistence” relates to the ability of the antiseptic to maintain its antimicrobial activity once it is applied and is connected with the retention of or binding of the agent on the respective surface, e.g. the stratum corneum of the skin, after partial evaporation and after rinsing. The persistence can be measured by the time required for the microflora to be restored to the baseline before the application.

Currently, there are several very fast acting antiseptics, effective within 20 seconds against pathogenic microorganisms, commercially available. Most of these antiseptics are based on alcohols, iodine solutions or chlorides. However, all the conventional fast acting antiseptics cannot prevent fast repopulation of the treated surface, such as skin. In particular in the latter case this effect is at last partially due to the fact that the natural body protection (fatty acids, presence of balanced salts, regulated pH etc.) against microbial invasions has also been destroyed.

Furthermore, WO 2013/001433 A1 discloses an antibiofilm coating containing fluoride salt nanoparticles based on magnesium fluoride. The coating of WO 2013/001433 A1 is in particular intended to be applied to the surface of devices, e.g. biomedical devices and implants. With other words, WO 2013/001433 A1 discloses a very limited use of magnesium fluoride in an immobilized form as coatings.

In view of this prior art, the object underlying the present invention is to provide further improved and optimized specific biocide compositions based on magnesium fluoride which are essentially non-toxic, show an excellent antimicrobial performance, long-term stability, and are advantageously applicable for a broad range of medical and non-medical applications.

This object is achieved according to the present invention by the composition of claims 1. More specific and preferred embodiments and aspects of the invention are the subject of further claims.

### DESCRIPTION OF THE INVENTION

The present invention provides a biocide composition in an aqueous solution according to claim 1 comprising at least the following components:
a) magnesium fluoride
b) a salicylic acid ester
c) at least one organic acid selected from the group comprising or consisting of cinnamic acid, rosmarinic acid, vanillic acid, ascorbic acid, abscisic acid, mandelic acid, mevalonic acid, aspartic acid, salicylic acid, fumaric acid, isocitric acid, gallic acid, quinic acid, boswellic acid, carnosic acid, chlorogene acid, caffeic acid, other hydroxyl carboxylic acids, or a salt or ester thereof, or thymol or citronellal,
d) a cationic polymer and/or natural sea salt or a synthetic equivalent thereof and/or a cationic tenside,
e) water.

Advantageously, the aqueous solution comprising MgF₂ has a pH less than 5.

Additionally to magnesium fluoride, the biocide composition of the present invention may further contain calcium fluoride as a component a).

The salicylic acid ester of component b) may be any ester suitable, in particular any ester which is water soluble and, in particular for medical applications, non-toxic and pharmacologically/physiologically acceptable in the concentrations used. Preferably, said ester is salicylic acid acetate (acetylsalicylic acid) or another ester of the hydroxyl group of salicylic acid with a lower alkyl carboxylic acid such as a C₃₋₁₇ carboxylic acid, more specifically a C₃₋₁₀ carboxylic acid.

The organic acid of component c) may be principally any carboxylic acid having antimicrobial activity which is non-toxic in the required concentration ranges.

Preferably the organic acid is selected from the group comprising or consisting of cinnamic acid, rosmarinic acid, vanillic acid, ascorbic acid, abscisic acid, mandelic acid, mevalonic acid, aspartic acid, salicylic acid, fumaric acid, isocitric acid, gallic acid, quinic acid, boswellic acid, carnosic acid, chlorogene acid, caffeic acid, other hydroxycarboxylic acids. A salt or ester of one or more of these compounds may be used as well.

Cinnamic acid represents a preferred component of the claimed composition. However, it is possible to substitute this compound by one or more of rosmarinic acid, vanillic acid, ascorbic acid, abscisic acid, mandelic acid, mevalonic acid, aspartic acid, salicylic acid, fumaric acid, isocitric acid, gallic acid or thymol or to combine cinnamic acid with one or more of these alternative compounds.

Also, a quinic acid, in particular D-(−)-quinic acid, represents a preferred component of the claimed composition. However, it is possible to substitute this compound by one or more of boswellic acid, carnosic acid, chlorogene acid, caffeic acid or to combine quinic acid with one or more of these alternative compounds.

The cationic polymer of component d) may be principally any cationic polymer having antimicrobial activity which is non-toxic for humans in the required concentration ranges for the respective applications. Preferably the cationic polymer is selected from the group comprising or consisting of a poly(alkylene)guanidin or -biguanidin, octenidin. Specific non-cationic polymers with antimicrobial activity such as polyethylene glycol may also be a component of the inventive compositions. Furthermore, it is assumed that the cationic group of the cationic polymer is advantageously less reactive with regard to the organic acids of the claimed composition.

Poly(alkylene)guanidines or -biguanidines can be prepared via the polycondensation of guanidinium salts, e.g. guanidinium hydrochloride, or, for biguanidines, sodium dicyanamide, with aliphatic diamines of a desired chain length (number of carbon atoms and methylene units in the molecule) by methods known in the art. The resulting polymers may by homopolymers or copolymers (if more than one diamine participates in said polycondensation).

More specifically, the cationic polymer is a poly(alkylene)guanidin or -biguanidin having a molecular weight in the range from 800 to 10,000, preferably 1,000 to 4,000 Dalton.

In a specific embodiment, the poly(alkylene)guanidines or poly(alkylene)biguanidines may have, e.g., an alkyl chain length of the monomer(s) in the range from C₂-C₁₄.

More specifically, the poly(alkylene)guanidine may be selected from the group comprising a poly(tetramethylen)guanidine, poly(hexa-methylen)guanidine (PHMG), a poly(octamethylen)guanidine, poly(decamethylen)guanidine, poly(dodecamethylen)guanidine or mixtures thereof.

In especially preferred embodiments, the cationic polymer is a poly(hexamethylen)guanidin (PHMG) or poly(hexamethylen)biguanidin (PHMB), in particular a lower PHMG or PMG having a molecular weight in the range as indicated above.

It is assumed that the surprisingly good results of the claimed composition is because the cationic polymer supports in particular the antimicrobial performance of magnesium fluoride (MgF₂). For example, PHMG is known as having a destructive impact on the membrane function of bacterial cells.

The natural sea salt or synthetic equivalent thereof may be any salt composition which provides the desired benefits. Typically, these salts have an electrolytic composition which promotes the constructive metabolism of the skin. Preferably, the sea salt is salt from the Dead Sea or a synthetic equivalent (having the same major components) thereof.

Preferably, the cationic tenside is selected from the group comprising or consisting of benzalkonium chloride, distearyldimethylammonium chloride, esterquat, cetrimonium bromide, cetylpyridinium chloride or any possible mixture thereof. The usage of the cationic tenside has proven to have a synergistic effect with magnesium fluoride (MgF₂) towards a notably fast-acting antimicrobial, in particular virucide, activity. Advantageously, the cationic tenside is used for providing a fast-acting disinfectant. It is assumed that the surprisingly good results of the claimed composition is based on the surface-active properties of the cationic tenside supporting in particular the performance of magnesium fluoride (MgF₂). Furthermore, it is assumed that the cationic group of the cationic tenside is advantageously less reactive with regard to the organic acids of the claimed composition.

More preferably one of the following salts KCl, MgCl₂, MgSO₄, NaCl, NaF is used in combination with the cationic tenside in order to improve the antimicrobial activity, in particular the virucide activity against unveiled viruses.

Optionally, the claimed composition may also comprise alginate compounds and a rheological agent, such as xanthan gum. These additives are preferably present in compositions which are used for wound care products, such as wound gels, wound dressings etc., or in cosmetic formulations.

The alginate may be present as calcium alginate or other alginate compounds known in the art. Short-chain alginates, preferably comprising 180 to 500 saccharide units, such as 150 to 300 units or 150 to 200 units, are preferred. Alginate supports healing processes i.a. by promoting the constructive metabolism of the skin.

It was especially surprising that the combination of alginate and (sea) salt improves the performance of the claimed composition with respect to its skin regenerating properties in a synergistic manner.

Rheological agents such as xanthan gum are used to adjust the viscosity and consistency of the respective composition as desired. Xanthan gum is a stable and neutral thickener in the acidic range. The skilled artisan will recognize that other agents with the same essential properties could be used as well.

The concentrations of the various compounds in the claimed biocide compositions may vary considerably depending from the respective specific application and the presence of other specific components.

Typically, component a) is present in a range from 5 ppm to 45.000 ppm, preferably from 10 ppm to 35.000 ppm,

component b) is present in a range from 5 ppm to 80.000 ppm, preferably from 500 ppm to 60.000 ppm,

component c) is present in a range from 5 ppm to 80.000 ppm, preferably from 10 ppm to 60.000 ppm,

component d) is present in a range from 5 ppm to 50.000 ppm, preferably from 50 ppm to 30.000 ppm,

component e) is present in a range from 745.000 ppm to 999.980 ppm, preferably from 868.000 ppm to 999.000 ppm, and optionally

component f) is present in a range from 5 ppm to 30.000 ppm, preferably from 500 ppm to 3000 ppm and/or

component g) is present in a range from 500 ppm to 15.000 ppm, preferably from 1000 ppm to 8000 ppm.

Suitable general ranges for a number of essential or preferred specific components are compiled in the following Table 1.

TABLE 1

| Component | Amount (in ppm of the total composition) |
|---|---|
| Acetylsalicylic acid | 5 ppm to 80.000 ppm |
| Cinnamic acid | 5 ppm to 15.000 ppm |
| D-(−)-Quinic acid | 5 ppm to 40.000 ppm |
| Ascorbic acid | 5 ppm to 80.000 ppm |
| Carnosic acid | 5 ppm to 40.000 ppm |
| Magnesium fluoride | 5 ppm to 35.000 ppm |
| Cationic polymer | 5 ppm to 40.000 ppm |
| Dead Sea salt | 5 ppm to 50.000 ppm |
| Alginate | 5 ppm to 30.000 ppm |

Preferred ranges for a number of essential or preferred components which are especially suited for an antiseptic or “physiologic” disinfectant, i.e. intended for contacting living tissue/skin, are compiled in the following Table 2.

TABLE 2

| Component | Amount (in ppm of the total composition) |
|---|---|
| Acetylsalicylic acid | 500 ppm to 2.000 ppm |
| Cinnamic acid | 500 ppm to 1.000 ppm |
| D-(−)-Quinic acid | 50 ppm to 1.000 ppm |
| Ascorbic acid | 5 ppm to 1.000 ppm |
| Carnosic acid | 5 ppm to 500 ppm |
| Magnesium fluoride | 10 ppm to 5.000 ppm |
| Cationic polymer | 50 ppm to 500 ppm |

An exemplary biocide composition which is essentially suited for an antiseptic or physiologic disinfectant as define above comprises or consists of the following components:
a) magnesium fluoride in an amount in the range from 10 ppm to 5.000 ppm,
b) a salicylic acid ester, preferably, acetylsalicylic acid, in an amount in the range from 500 ppm to 2000 ppm,
c1) cinnamic acid in an amount in the range from 500 ppm to 2.000 ppm
c2) quinic acid in an amount in the range from 50 ppm to 1.000 ppm,
d) a cationic polymer in an amount in the range from 50 ppm to 500 ppm,
e) water in an amount in the range from 989.500 to 998.890.

Preferred ranges for a number or essential or preferred components which are especially suited for a (non-physiologic) disinfectant for surface treatment of other surfaces than skin or living tissue are compiled in the following Table 3.

TABLE 3

| Component | Amount (in ppm of the total composition) |
|---|---|
| Acetylsalicylic acid | 500 ppm to 2.500 ppm |
| Cinnamic acid | 500 ppm to 1.500 ppm |
| D-(−)-Quinic acid | 50 ppm to 2.000 ppm |
| Carnosic acid | 5 ppm to 1.000 ppm |
| Magnesium fluoride | 10 ppm to 10.000 ppm |
| Cationic polymer | 50 ppm to 4.000 ppm |

An exemplary biocide composition which is especially suited for a non-physiologic disinfectant for surface treatment comprises or consists of the following components:
a) magnesium fluoride in an amount in the range from 10 ppm to 10.000 ppm,
b) a salicylic acid ester, preferably, acetylsalicylic acid, in an amount in the range from 500 ppm to 2500 ppm,
c1) cinnamic acid in an amount in the range from 500 ppm to 1.500 ppm
c2) quinic acid in an amount in the range from 50 ppm to 2.000 ppm,
d) a cationic polymer in an amount in the range from 50 ppm to 4000 ppm,
e) water in an amount in the range from 980.000 to 998.890.

Preferred ranges for a number of essential or preferred components which are especially suited for a medical formulation for antiseptic wound care or the treatment of diseases caused by pathogens (such as viruses, bacteria, fungi) are compiled in the following Table 4.

TABLE 4

| Component | Amount (in ppm of the total composition) |
|---|---|
| Acetylsalicylic acid | 500 ppm to 2.500 ppm |
| Cinnamic acid | 500 ppm to 1.500 ppm |
| D-(−)-Quinic acid | 500 ppm to 2.000 ppm |
| Ascorbic acid | 800 ppm to 2.000 ppm |
| Magnesium fluoride | 16 ppm to 30.000 ppm |
| Dead Sea salt | 200 ppm to 3.000 ppm |
| Alginate | 500 ppm to 3.000 ppm |
| Xanthan gum | 1.000 ppm to 8.000 ppm |

Preferred ranges for a number of essential or preferred components which are especially suited for additives to construction materials and paints are compiled in the following Table 5.

TABLE 5

| Component | Amount (in ppm of the total composition) |
|---|---|
| Acetylsalicylic acid | 2500 ppm to 60.000 ppm |
| Cinnamic acid | 500 ppm to 10.000 ppm |
| Carnosic acid | 200 ppm to 5.000 ppm |
| Magnesium fluoride | 160 ppm to 35.000 ppm |
| Cationic polymer | 200 ppm to 30.000 ppm |

An exemplary biocide composition which is especially suited for additive for construction materials and paints comprises or consists of the following components:
a) magnesium fluoride in an amount in the range from 160 ppm to 35.000 ppm,
b) a salicylic acid ester, preferably acetylsalicylic acid, in an amount in the range from 2.500 ppm to 60.000 ppm,
c1) cinnamic acid in an amount in the range from 500 ppm to 10.000 ppm,
c2) carnosic acid in an amount in the range from 0 ppm to 5.000 ppm,
d) a cationic polymer in an amount in the range from 50 ppm to 30.000 ppm,
e) water in an amount in the range from 855.000 to 995.790.
f) CaSO₄ in an amount in the range from 1000 ppm to 5000 ppm.

An exemplary biocide composition which is especially suited for additive for a medical formulation for antiseptic wound care or the treatment of diseases caused by pathogens (such as viruses, bacteria fungi) comprises or consists of the following components:
a) magnesium fluoride in an amount in the range from 16 ppm to 30.000 ppm,
b) a salicylic acid ester, preferably acetylsalicylic acid, in an amount in the range from 500 ppm to 2.500 ppm,
c1) cinnamic acid in an amount in the range from 500 ppm to 1.500 ppm,
c2) quinic acid in an amount in the range from 500 ppm to 2.000 ppm,
d) a natural salt from the Dead Sea or a synthetic equivalent thereof in an amount in the range from 200 ppm to 3.000 ppm,
e) water in an amount in the range from 950.000 to 996.784.
f) alginate in an amount in the range from 500 ppm to 3.000 ppm,
g) xanthan gum in an amount in the range from 1.000 ppm to 8.000 ppm.

This composition or a similar composition may also be used in cosmetic formulations, in particular skin care or hair care products.

The compositions of the present invention, in particular those wherein component d) is a cationic polymer, preferably a poly(alkylene)-guanidine or -biguanidine or octenidin, more preferred a poly(alkylene)guanidine, are also suitable as a crop protecting agent or product.

Preferred ranges for a number of essential or preferred components which are especially suited for a crop protection product are compiled in the following Table 6.

TABLE 6

| Component | Amount (in ppm of the total composition) |
|---|---|
| Magnesium fluoride | 5 to 35′000 |
| Acetylsalicylic acid | 5 to 80′000 |
| Organic acid | 5 to 80′000 |
| Cationic polymer | 5 to 50′000 |
| Water | 785′000 to 999,980 |
| Alginate | 500 to 3′000 |
| Salt | 200 to 3′000 |

Preferred ranges for a number of essential or preferred components which are especially suited for a fast-acting disinfectant are compiled in the following Table 7.

TABLE 7

| Component | Amount (in ppm of the total composition) |
|---|---|
| Magnesium fluoride | 10 to 5.000 |
| Acetylsalicylic acid | 500 to 2′500 |
| Organic acid | 50 to 1′000 |
| Cationic tenside | 5 to 20′000 |
| Water | 896′000 to 999′175 |
| Alginate | 250 to 50′000 |
| Salt | 10 to 30′000 |

It has been proven that, advantageously, alginate improves the long-time activity of the fast-acting disinfectant.

Advantageously, the biocide compositions of the present invention are free of ethanol, propanol, hypochlorite or hydrogen peroxide.

The claimed aqueous biocide compositions and gels are fast acting, persistent and long term-stable, such as for a time period of at least 3 years.

As already mentioned above, the biocide compositions of the invention are suitable for a broad range of applications including the provision of antimicrobial activity on living tissue/skin, such as antiseptic medical formulations or physiologic disinfectants, and/or the provision of antimicrobial activity or prevention of microbial activity, in particular fungal activity, in non-living objects, such as additives to construction materials and paints.

Consequently more specific aspects of the invention relate to the use of such compositions as a physiologic disinfectant as a general non-physiologic surface disinfectant, as an additive for construction materials and paints, as a crop protecting agent, as an antiseptic medical formulation for the treatment of diseases caused by pathogens such as bacteria, fungi and viruses, and to the use in an antiseptic wound gel or an antiseptic wound dressing. A still further aspect of the invention relates to the use of such compositions in an antiseptic cosmetic formulation.

Further, closely related aspects of the invention relate to a disinfectant comprising or consisting of such compositions for the treatment of physiologic surfaces, i.e. surfaces which comprise living tissue or skin, or for non-physiologic surfaces, i.e. surfaces which are not comprising living tissue or skin, to an additive, in particular antimycotic additive, for construction materials and paints, which additive comprises or consists of such compositions, to a crop protecting product, to an antiseptic wound gel comprising or consisting of such composition, to an antiseptic cosmetic formulation, in particular a skin care or hair care product, which comprises or consists of such a composition, and to an antiseptic medical formulation for the treatment of diseases caused by pathogens such as bacteria, fungi and viruses, comprising or consisting of such a composition.

A still further aspect of the invention relates to a method for treating diseases, in particular diseases which affect the skin, caused by pathogens such as bacteria, fungi and viruses which method comprises the topical application of an antiseptic formulation comprising or consisting of such a composition onto skin or tissue of a subject suffering from such a disease.

The composition of the present invention may be used in variety of forms, as appropriate for the respective application. The may be used as an aqueous solution or suspension, including a composition suitable for application as a spray, as a gel or cream, etc. They may be used as such or combined with other active principles or carrier materials (e.g. in a wound-dressing).

The present invention is further illustrated by the following non-limiting Examples.

### EXAMPLE 1

A biocide composition for use as a physiologic disinfectant or antiseptic was prepared by mixing the following components in the indicated ratios

| Component | Amount (in ppm of the total composition) | |
|---|---|---|
| Acetylsalicylic acid | 2.000 | ppm |
| Cinnamic acid | 500 | ppm |
| D-(−)-Quinic acid | 500 | ppm |
| Magnesium fluoride | 130 | ppm |
| PHMG | 25 | ppm |
| Citronellal | 25 | ppm |
| Water | 996.820 | ppm |

and tested with respect to its performance.

### EXAMPLE 2

A biocide composition for use as a non-physiologic surface disinfectant was prepared by mixing the following components in the indicated ratios

| Component | Amount (in ppm of the total composition) | |
|---|---|---|
| Acetylsalicylic acid | 2.000 | ppm |
| Cinnamic acid | 500 | ppm |
| D-(−)-Quinic acid | 500 | ppm |
| Magnesium fluoride | 130 | ppm |
| PHMG | 25 | ppm |
| Water | 996.845 | ppm |

and tested with respect to its performance.

### EXAMPLE 3

A biocide composition for use as an antiseptic medical formulation for the treatment of diseases caused by pathogens (bacteria, fungi and viruses) was prepared by mixing the following components in the indicated ratios

| Component | Amount (in ppm of the total composition) | |
|---|---|---|
| Acetylsalicylic acid | 2.000 | ppm |
| Cinnamic acid | 1.000 | ppm |
| D-(−)-Quinic acid | 1.000 | ppm |
| Magnesium fluoride | 2.600 | ppm |
| Dead Sea Salt | 1.000 | ppm |
| Alginate | 1.500 | ppm |
| Xanthan gum | 3.400 | ppm |
| Water | 997.500 | ppm |

and tested with respect to its performance.

### EXAMPLE 4

A biocide composition for use as an antimycotic additive to construction materials and paints was prepared by mixing the following components in the indicated ratios

| Component | Amount (in ppm of the total composition) | |
|---|---|---|
| Acetylsalicylic acid | 10.000 | ppm |
| Cinnamic acid | 5.000 | ppm |
| Magnesium fluoride | 4.000 | ppm |
| PHMG | 20.000 | ppm |
| Calcium sulphate | 2.000 | ppm |
| Water | 959.000 | ppm |

added to paint in a desired concentration and tested with respect to its performance.

### EXAMPLE 5

A biocide composition for use in an antiseptic wound gel was prepared by mixing the following components in the indicated ratios

| Component | Amount (in ppm of the total composition) | |
|---|---|---|
| Acetylsalicylic acid | 2.000 | ppm |
| Cinnamic acid | 1.000 | ppm |
| D-(−)-Quinic acid | 1.000 | ppm |
| Magnesium fluoride | 2.600 | ppm |
| Dead Sea Salt | 1.000 | ppm |
| Alginate | 1.500 | ppm |
| Xanthan gum | 3.400 | ppm |
| Water | 988.500 | ppm |

and tested with respect to its performance.

### EXAMPLE 6

A biocide composition for use as a crop protection product was prepared by mixing the following components in the indicated ratios

| Component | Amount (in ppm of the total composition) |
|---|---|
| Magnesium fluoride | 450 |
| Acetylsalicylic acid | 2′500 |
| Cinnamic acid | 1′350 |
| PHMG | 5′550 |
| Water | 990′150 |

### EXAMPLE 7

A biocide composition for use as a fast-acting disinfectant was prepared by mixing the following components in the indicated ratios

| Component | Amount (in ppm of the total composition) |
|---|---|
| Magnesium fluoride | 100 |
| Acetylsalicylic acid | 2′000 |
| Cinnamic acid | 1′000 |
| Benzalkonium chloride (BAC) | 40 |
| Water | 996′860 |

1. A biocide composition in an aqueous solution comprising at least the following components:
a) magnesium fluoride,
b) a salicylic acid ester,
c) at least one organic acid selected from the group consisting of cinnamic acid, rosmarinic acid, vanillic acid, ascorbic acid, abscisic acid, mandelic acid, mevalonic acid, aspartic acid, salicylic acid, fumaric acid, isocitric acid, gallic acid, quinic acid, boswellic acid, carnosic acid, chlorogene acid, caffeic acid, other hydroxycarboxylic acids, a salt thereof, an ester thereof, thymol and citronellal,
d) at least one of a cationic polymer, a natural sea salt, a synthetic equivalent of a natural sea salt, and a cationic tenside, and
e) water.

2. The biocide composition according to claim 1, wherein the cationic polymer is selected from the group consisting of a poly(alkylene)guanidine, a poly(alkylene)biguanidin and octenidin.

3. The biocide composition according to claim 1, wherein the cationic polymer is a poly(alkylene)guanidin or a poly(alkylene)biguanidin having a molecular weight in a range from 800 to 10,000 Dalton.

4. The biocide composition according to claim 2, wherein a monomer of the poly(alkylene)guanidine or poly(alkylene)biguanidine has an alkyl chain length from C₂-C₁₄.

5. The biocide composition according to claim 2, wherein the poly(alkylene)guanidine is selected from the group consisting of poly(tetramethylen)guanidine, poly(hexa-methylen)guanidine (PHMG), poly(octamethylen)guanidine, poly(decamethylen)guanidine, poly(dodecamethylen)guanidine and mixtures thereof.

6. The biocide composition according to claim 2, wherein the cationic polymer is poly(hexamethylen)guanidin (PHMG) or poly(hexamethylen)biguanidin (PHMB).

7. The biocide composition according to claim 1, wherein the sea salt comprises natural salt from the Dead Sea or a synthetic equivalent thereof.

8. The biocide composition according to claim 1, which further comprises
f) alginate, and
g) a rheological agent.

9. The biocide composition according to claim 1, wherein
component a) is present in a range from 5 ppm to 45,000 ppm,
component b) is present in a range from 5 ppm to 85,000 ppm,
component c) is present in a range from 5 ppm to 80,000 ppm,
component d) is present in a range from 5 ppm to 50,000 ppm,
component e) is present in a range from 745,000 ppm to 999,980 ppm, and
optionally
component f) is present in a range from 5 ppm to 30,000 ppm, and/or
component g) is present in a range from 500 ppm to 15,000 ppm.

10. The biocide composition according to claim 9, wherein
component f) is present in a range from 5 ppm to 30,000 ppm, and
component g) is present in a range from 500 ppm to 15,000 ppm.

11. The biocide composition according to claim 1, comprising
a) magnesium fluoride in an amount in the range from 10 ppm to 5,000 ppm,
b) a salicylic acid ester, in an amount in the range from 500 ppm to 2,000 ppm,
c1) cinnamic acid in an amount in the range from 500 ppm to 2,000 ppm,
c2) quinic acid in an amount in the range from 50 ppm to 1,000 ppm,
d) a cationic polymer in an amount in the range from 50 ppm to 500 ppm, and
e) water in an amount in the range from 989,500 to 998,890.

12. The biocide composition according to claim 1, comprising
a) magnesium fluoride in an amount in the range from 10 ppm to 10,000 ppm,
b) a salicylic acid ester in an amount in the range from 500 ppm to 2500 ppm,
c1) cinnamic acid in an amount in the range from 500 ppm to 1,500 ppm,
c2) quinic acid in an amount in the range from 50 ppm to 2,000 ppm,
d) a cationic polymer in an amount in the range from 50 ppm to 4,000 ppm, and
e) water in an amount in the range from 980,000 to 998,890 ppm.

13. The biocide composition according to claim 1, comprising
a) magnesium fluoride in an amount in the range from 160 ppm to 35,000 ppm,
b) a salicylic acid ester, in an amount in the range from 2,500 ppm to 60,000 ppm,
c1) cinnamic acid in an amount in the range from 500 ppm to 10,000 ppm,
c2) carnosic acid in an amount in the range from 0 to 5,000 ppm,
d) a cationic polymer in an amount in the range from 200 ppm to 30,000 ppm,
e) water in an amount in the range from 885,000 ppm to 995,790 ppm, and
f) CaSO₄ in an amount in the range from 1000 ppm to 5000 ppm.

14. The biocide composition according to claim 8, comprising
a) magnesium fluoride in an amount in the range from 16 ppm to 30,000 ppm,
b) a salicylic acid ester, in an amount in the range from 500 ppm to 3,000 ppm,
c1) cinnamic acid in an amount in the range from 500 ppm to 1,500 ppm,
c2) quinic acid in an amount in the range from 500 ppm to 2,000 ppm,
d) natural salt from the Dead Sea or a synthetic equivalent thereof in an amount in the range from 200 ppm to 3,000 ppm,
e) water in an amount in the range from 950,000 to 996,784,
f) alginate in an amount in the range from 500 ppm to 3,000 ppm, and
g) xanthan gum in an amount in the range from 1,000 ppm to 8,000 ppm.

15. The biocide composition according to claim 1, which is free of ethanol, propanol, hypochlorite or hydrogen peroxide.

16. The biocide composition of claim 1, which is a physiologic disinfectant effective for treating surfaces comprising living tissue or skin.

17. The biocide composition according to claim 1, which is a surface disinfectant for non-physiologic surfaces not comprising living tissue or skin.

18. The biocide composition according to claim 1, which is an additive for construction materials and paints.

19. The biocide composition according to claim 1, which is an antiseptic medical formulation for treating diseases caused by pathogens.

20. (canceled)

21. The biocide composition according to claim 1, which is an antiseptic wound gel.

22. The biocide composition according to claim 1, which is in an antiseptic cosmetic formulation.

23. A disinfectant comprising a composition according to claim 1 for treating physiologic surfaces, which comprise living tissue or skin.

24. A surface disinfectant for non-physiologic surfaces, which do not comprise living tissue or skin, wherein the surface disinfectant comprises a composition according to claim 1.

25. An additive for construction materials and paints, wherein the additive comprises a composition according to claim 1.

26. An antiseptic wound gel comprising a composition according to claim 1.

27. An antiseptic cosmetic formulation for skin or hair care, which comprises a composition according to claim 1.

28. An antiseptic medical formulation for treating diseases caused by pathogens, wherein the antiseptic medical formulation comprises a composition according to claim 1.

29. A method for treating a disease affecting the skin caused by pathogens, said method comprising a topical application of an antiseptic formulation comprising a composition according to claim 1 onto skin or tissue of a subject suffering from the disease.

30. The biocide composition according to claim 1, which is a crop protecting product.

31. The biocide composition according to claim 30, wherein the cationic polymer is a poly(alkylene)guanidine.

32. The biocide composition according to claim 1, wherein component d) is a poly(alkylene)guanidine, and the biocide composition is a crop protecting product.
